(19) United States
(12) Patent Application Publication
(10) Pub. No.: US 2008/0234869 A1
(43) Pub. Date: Sep. 25, 2008

(54) Remote Performance Monitor and Remote Performance Monitoring Method

(76) Inventors: Kenzo Yonezawa, Tokyo (JP); Yasuo Takagi, Chigasaki-shi (JP); Yasuyuki Ito, Yokohama-shi (JP); Yoshiki Murakami, Yokohama-shi (JP); Nobutaka Nishimura, Tokyo (JP); Nobuyuki Donen, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/051,111

(22) Filed: Mar. 19, 2008

(30) Foreign Application Priority Data
Mar. 20, 2007 (JP) P2007-072607

(51) Int. Cl. G01M 1/38; F24F 12/00

(52) U.S. Cl. 700/276; 236/49.3

(57) ABSTRACT

A remote performance monitor to acquire monitoring data concerning an air-conditioning system of a monitoring target building and to determine an operating condition of the air-conditioning system, the remote performance monitor comprises a monitoring data receiver (11), a characteristic function calculator (12) and an operating condition calculator (13). The monitoring data receiver (11) receives monitoring data from a monitoring data collecting apparatus in the monitoring target building. The monitoring data is data concerning performance characteristics of air-conditioning machines installed in the air-conditioning system of the monitoring target building. The characteristic function calculator (12) calculates a characteristic function for the monitoring target building and for each of the air-conditioning machines based on the monitoring data. The operating condition calculator (13) calculates operating condition data to minimize a sum of amounts of energy consumed by the air-conditioning machines by using the characteristic function.

### BACKGROUND OF THE INVENTION

1. Field of the Invention

The present invention relates to a remote performance monitor and a remote performance monitoring method configured to acquire monitoring data concerning an air-conditioning system of a monitoring target building and to determine an operating condition of the air-conditioning system.

2. Description of the Related Art

Numerous techniques have heretofore been disclosed concerning remote monitoring, which is to monitor a monitoring target device from a place away from a site where the monitoring target device is installed. The techniques concerning this remote monitoring have also been applied to the purpose of monitoring building facilities such as an air-conditioning system.

Along the development in the communication technology, there has been a technique to acquire necessary signals from an air-conditioning system and to transmit the signals to a remote monitoring center in the distance. In the past, it was necessary to send an expert to each building in order to attend monitoring on site. However, according to this technique, it is possible to monitor numerous air-conditioning systems located in many places with a small number of experts at any time. Hence many advantages are obtained from this technique.

One of the techniques concerning remote monitoring is a remote monitoring method applying two communication lines installed in parallel in order to ensure compatibility between a proprietary communication protocol defined by a manufacturer and a de facto standard communication protocol (see Japanese Patent Application Publication No. 2005-274125, for example). Japanese Patent Application Publication No. 2005-274125 discloses a method of remotely monitoring an air conditioner by installing two communication lines in parallel.

Meanwhile, there is an apparatus configured to monitor a condition of a building by use of data acquired by remote monitoring (see Japanese Patent Application Publication No. 2005-182441, for example). An analyzer apparatus for building facility management disclosed in this Japanese Patent Application Publication No. 2005-182441 includes a communication interface, an analytical data collector-processor, an inference rule storage unit, an inference unit and an output unit. The communication interface receives a communication signal containing information necessary for managing an operating condition of a facility installed in a building. The analytical data collector-processor extracts the information out of the received communication signal and stores the information in an analytical data storage unit. The inference rule storage unit stores an inference process program in advance, which is configured to infer a cause of unachieved management objective when the operating condition of the facility does not reach the management objective condition thereof. The inference unit analyzes the information in accordance with the inference process program and thereby infers the cause. The output unit displays a result of inference by the inference unit. In this way, the cause of unachieved management objective is inferred when the operating condition of the facility does not reach the management objective condition.

Meanwhile, a conventional air-conditioning system has poor accuracy caused by handling a fluid. Accordingly, the conventional air-conditioning system had problems of disabilities to detect a predictor of breakdown, to absorb individual differences among actual machines in a breakdown judgment and to judge the cause of the breakdown. To solve these problems, there has been disclosed the following fluid circuit diagnosis method (see Japanese Patent Application Publication No. 2005-351618). In this method, firstly detected are multiple measured amounts, such as pressure, temperature and other factors of a coolant for a refrigeration cycle apparatus or the like. Then, by use of these measured amounts, a state quantity such as a composite variable is calculated. Finally, it is judged, from the result of the calculation, whether or not the apparatus is normal. In the method disclosed in Japanese Patent Application Publication No. 2005-351618, the current state of the refrigeration cycle apparatus is allowed to be judged by learning state of normal operation. Moreover, in the method disclosed in Japanese Patent Application Publication No. 2005-351618, a breakdown such as an operating limit is allowed to be predicted from variation in the Mahalanobis' generalized distance by learning the state of the apparatus forcedly performing abnormal operation, or by calculating an abnormal operating state at the time of current operation. Accordingly, Japanese Patent Application Publication No. 2005-351618 discloses a solution involving achievement of reliable diagnosis with a simple configuration, which has a large effect for remote monitoring for abnormalities in the distance.

As described above, the conventional techniques have achieved the apparatuses with functions for sending and receiving basic signals for exchanging signals to achieve remote monitoring. The technique disclosed in Japanese Patent Application Publication No. 2005-351618 further achieves a logical function for judging whether a monitoring target facility is in normal state.

However, the above-described conventional techniques are merely able to achieve detection of a breakdown of a facility by means of remote monitoring and have not been able to achieve support in operation appropriately in response to specifications of respective facilities. For example, constructions such as buildings have various conditions including locations, sizes, structures, capacities, and so forth. It is therefore important in light of cost saving and energy saving to conduct the optimum operations while considering various conditions of the constructions.

### SUMMARY OF THE INVENTION

It therefore is an object of the present invention to provide a remote performance monitor and a remote performance monitoring method which support an appropriate operation of an air-conditioning system of a building considering a condition of the building.

According to an aspect of the present invention, a remote performance monitor configured to acquire monitoring data concerning an air-conditioning System of a monitoring target building and to determine an operating condition of the air-conditioning system, the remote performance monitor comprises a monitoring data receiver which receives monitoring data from a monitoring data collecting apparatus in the monitoring target building, wherein the monitoring data is data concerning performance characteristics of air-conditioning machines installed in the air-conditioning system of the monitoring target building, a characteristic function calculator which calculates a characteristic function for the monitoring target building and for each of the air-conditioning machines based on the monitoring data and an operating condition calculator which calculates operating condition data to minimize a sum of amounts of energy consumed by the air-conditioning machines by using the characteristic function.

According to the other aspect of the present invention, a remote performance monitoring method configured to acquire monitoring data concerning an air-conditioning system of a monitoring target building and to determine an operating condition of the air-conditioning system, the remote performance monitoring method comprises receiving monitoring data from a monitoring data collecting apparatus in the monitoring target building, wherein the monitoring data is data concerning performance characteristics of air-conditioning machines installed in the air-conditioning system of the monitoring target building, calculating a characteristic function for the monitoring target building and for each of the air-conditioning machines based on the monitoring data; and calculating operating condition data to minimize the sum of amounts of energy consumed by the air-conditioning machines by using the characteristic function.

According to the other aspect of the present invention, a remote performance monitor configured to acquire monitoring data concerning an air-conditioning system of a monitoring target building and to determine an operating condition of the air-conditioning system, the remote performance monitor comprises a monitoring data receiver configured to receive monitoring data from a monitoring data collecting apparatus in the monitoring target building, wherein the monitoring data is data concerning performance characteristics of air-conditioning machines installed in the air-conditioning system of the monitoring target building, a characteristic function calculator configured to calculate a characteristic function for the monitoring target building and for each of the air-conditioning machines based on the monitoring data and a parameter sender configured to send parameters of the characteristic function which is calculated by the characteristic function calculator.

According to the other aspect of the present invention, a remote performance monitoring method configured to acquire monitoring data concerning an air-conditioning system of a monitoring target building and to determine an operating condition of the air-conditioning system, the remote performance monitoring method comprises receiving monitoring data from a monitoring data collecting apparatus in the monitoring target building, wherein the monitoring data is data concerning performance characteristics of air-conditioning machines installed in the air-conditioning system of the monitoring target building, calculating a characteristic function for the monitoring target building and for each of the air-conditioning machines based on the monitoring data and sending parameters of the characteristic function which is calculated by the calculating step.

### BRIEF DESCRIPTION OF DRAWINGS

FIG. 1 is a view for explaining a system configuration of a remote performance monitoring system and functional blocks of a remote performance monitor according to an embodiment of the present invention.

FIG. 2 is a flowchart for explaining a process to be executed by the remote performance monitoring system according to the embodiment of the present invention.

FIG. 3 is a view for explaining an example of a general central chiller type air-conditioning system.

FIG. 4 is a view for explaining input and output data in the case of applying the remote performance monitor according to the embodiment of the present invention to the central chiller type air-conditioning system.

FIG. 5A is an example of monitoring data to be received by the remote performance monitoring system according to the embodiment of the present invention, which is the example of monitoring data concerning power consumption.

FIG. 5B is an example of monitoring data to be received by the remote performance monitoring system according to the embodiment of the present invention, which is the example of monitoring data concerning room conditions.

FIG. 5C is an example of monitoring data to be received by the remote performance monitoring system according to the embodiment of the present invention, which is the example of monitoring data concerning cooling water.

FIG. 5D is an example of monitoring data to be received by the remote performance monitoring system according to the embodiment of the present invention, which is the example of monitoring data concerning COP (coefficient of performance).

FIG. 6 is a view for explaining an example of a general multi packaged type air-conditioner system.

FIG. 7 is a view for explaining an installation example of indoor units in the case of the general multi packaged type air-conditioner system.

FIG. 8 is a view for explaining input and output data in the case of applying the remote performance monitor according to the embodiment of the present invention to the multi packaged type air-conditioner system.

FIG. 9 is a view for explaining a system configuration of a remote performance monitoring system and functional blocks of a remote performance monitor according to another embodiment of the present invention.

### DETAILED DESCRIPTION OF THE INVENTION

### (Remote Performance Monitoring System)

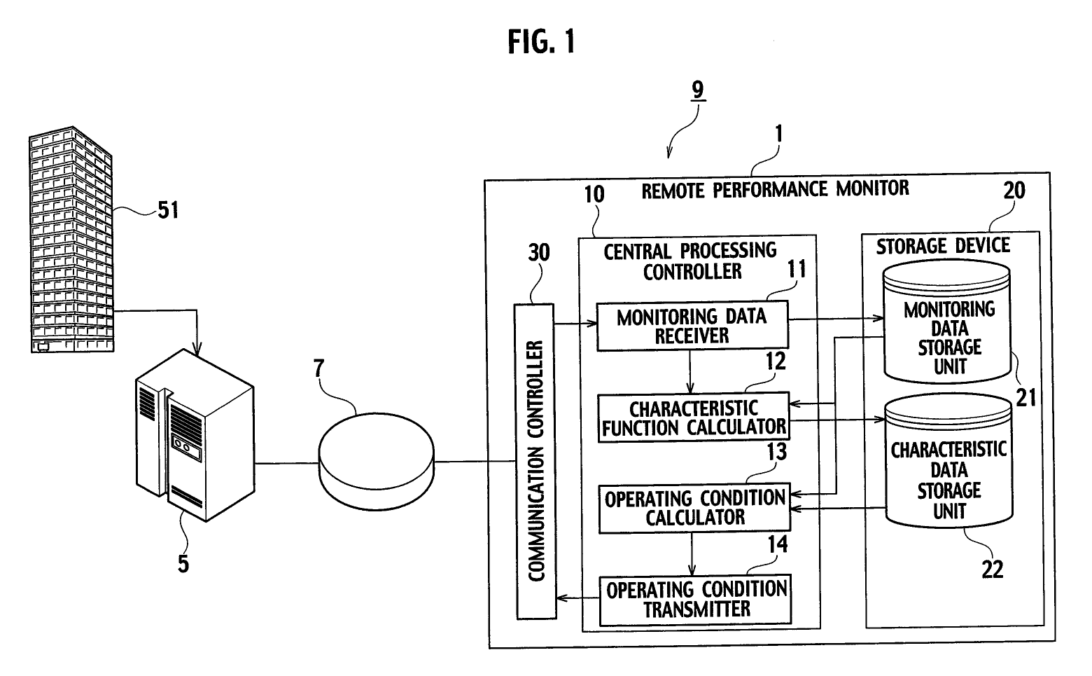

FIG. 1 is a system configuration view of a remote performance monitoring system 9 according to an embodiment of the present invention. The remote performance monitoring system 9 includes a monitoring target building 51, a monitoring data collecting apparatus 5, and a remote performance monitor 1. The monitoring data collecting apparatus 5 monitors the monitoring target building 51. In FIG. 1, the remote performance monitoring system 9 includes the single monitoring target building 51 and the single monitoring data collecting apparatus 5. Alternatively, the remote performance monitoring system 9 may include multiple monitoring target buildings 51 and multiple monitoring data collecting apparatuses 5. The monitoring data collecting apparatus 5 and the remote performance monitor 1 are mutually connected trough a communication network 7 such as the Internet.

The monitoring target building 51 includes air-conditioning machines concerning air-conditioning. When the monitoring target building 51 uses a central chiller type air-conditioning system, the air-conditioning machine includes more than one central chiller, more than one cooling tower, more than one air conditioner, more than one cool water pump, more than one cooling water pump, more than one air fan. When the monitoring target building 51 is a multi packaged type air-conditioner includes air conditioners such as outdoor unit and indoor unit. The air-conditioning system of the monitoring target building 51 will be described later in detail.

The monitoring data collecting apparatus 5 is, for example, information equipment installed inside the monitoring target building 51. The monitoring data collecting apparatus 5 is connected electrically to each air-conditioning machine provided therein. The monitoring data collecting apparatus 5 collects monitoring data indicating performance characteristics of the air-conditioning machines from the respective air-conditioning machines in the monitoring target building 51, and transmits the data to the remote performance monitor 1. The monitoring data are the data measured by the respective air-conditioning machines in the monitoring target building 51. The monitoring data include data concerning performance characteristics as well as energy consumption of the respective air-conditioning machines. For example, when the air-conditioning machine is the central chiller, the monitoring data include a chilled water temperature of chilled water produced by the central chiller, a flow rate of the chilled water, a cooling water temperature of cooling water taken into the central chiller, and a flow rate of the cooling water. Further, the monitoring data collecting apparatus 5 receives operating conditions of the respective air-conditioning machines from the remote performance monitor 1. These operating conditions are outputted from the remote performance monitor 1 based on the monitoring data. The monitoring data collecting apparatus 5 may determine settings of the respective air-conditioning machines of the monitoring target building 51 by making reference to the received operating conditions. Moreover, the monitoring data collecting apparatus 5 may include a function to apply the received operating conditions to operating conditions of the respective air-conditioning machines installed in the monitoring target building 51.

The remote performance monitor 1 acquires the monitoring data concerning the air-conditioning system of the monitoring target building 51 and determines operating conditions of the air-conditioning system. To be more precise, the remote performance monitor 1 determines, based on the monitoring data received from the monitoring data collecting apparatus 7, performance characteristics of the monitoring target building 51 and of the respective air-conditioning machines in the monitoring target building 51. Moreover, the remote performance monitor 1 determines, on the basis of the respective performance characteristics thus determined, the operating conditions of the respective air-conditioning machines so as to optimize energy efficiency in the air-conditioning system in the monitoring target building 51. The remote performance monitor 1 transmits the determined operating conditions to the monitoring data collecting apparatus 7.

### (Remote Performance Monitor)

Next, the remote performance monitor 1 according to the embodiment of the present invention will be described in detail with reference to FIG. 1.

The remote performance monitor 1 includes a central processing controller 10, a storage device 20 and a communication controller 30. In addition, the remote performance monitor 1 further includes various other devices such as a ROM, a RAM or a bus. The central processing controller 10 controls processes to be executed by the remote performance monitor 1. The storage device 20 stores data used in the course of processes by the central processing controller 10 and data representing process results. The communication controller 30 is the device to be an interface for establishing connection between the remote performance monitor 1 and the communication network 7.

A monitoring data receiver 11, a characteristic function calculator 12, an operating condition calculator 13, and an operating condition transmitter 14 are implemented on the central processing controller 10 by installing a remote characteristic monitoring program on the remote performance monitor 1. The storage device 20 includes a monitoring data storage unit 21 and a characteristic data storage unit 22.

The monitoring data receiver 11 receives monitoring data concerning performance characteristics of the respective air-conditioning machines installed in the air-conditioning system of the monitoring target building 51 from the monitoring data collecting apparatus 52 of the monitoring target building 51. Here, the performance characteristic is index for evaluating performance of the air-conditioning machine installed in the air-conditioning system of the monitoring target building 51. The performance characteristics may beset up depending on the type of the air-conditioning system or individually for each of the air-conditioning machines.

The monitoring data receiver 11 receives the monitoring data from the monitoring data collecting apparatus 5 through the communication network 7 and the communication controller 30. The monitoring data receiver 11 may acquire the monitoring data from the monitoring data collecting apparatus 5 by sending a request concerning acquisition of the monitoring data to the monitoring data collecting apparatus 5. Alternatively, the monitoring data receiver 11 may receive the monitoring data by causing the monitoring data collecting apparatus 5 to transmit the monitoring data periodically to the remote performance monitor 1. The monitoring data receiver 11 may receive the monitoring data for each of multiple monitoring target buildings 51 from multiple monitoring data collecting apparatuses 5.

The monitoring data receiver 11 stores the received monitoring data in the monitoring data storage unit 21 of the storage device 20. Here, the monitoring data receiver stores, in the monitoring data storage unit 21, the monitoring data associated with an identifier of the monitoring building 51, received date and the like.

The characteristic function calculator 12 calculates a characteristic function for the monitoring target building 51 and for each of the air-conditioning machines provided in the monitoring target building 51. The characteristic function calculator 12 calculates the characteristic function indicating the performance characteristic of the monitoring target building 51 and calculates the characteristic functions indicating the performance characteristics of the respective air-conditioning machines. The characteristic function for each of the air-conditioning machines is a function of machine characteristic which varies depending on deterioration or other factors of the air-conditioning machine, for example. The characteristic function calculator 12 finds the characteristic functions based on the acquired monitoring data when the monitoring data receiver 11 accumulates the monitoring data for a predetermined time period in the monitoring data storage unit 21.

In order to find the characteristic function, there are a method of finding an optimal solution by using rigorous mathematical programming and a method of finding a linear algebraic equation by linear approximation of the characteristic of each of the air-conditioning machines and outputting the linear algebraic equation as a specific function.

Here, a method of finding the specific function by use of the linear algebraic equation will be described. When finding the specific function for the central chiller in the air-conditioning system of the monitoring target building 51, for example, the characteristic function calculator 12 approximates a COP (coefficient of performance: here, energy consumption efficiency) of the central chiller according to the monitoring data, which are received by the monitoring data receiver 11, by a linear function f=ax+b. Here, the COP is a value expressing cooling or heating power for 1 kW of power consumption. The parameter x is a vector containing such elements as the temperature of the chilled water produced by the central chiller, the flow rate of the chilled water, the temperature of the cooling water taken into the central chiller, or the flow rate of the cooling water. The characteristic function calculator 12 outputs this linear function f=ax+b as the characteristic function of the central chiller.

The characteristic function calculator 12 stores, as characteristic data, in the characteristic data storage unit 22 in the storage device 20, the information concerning characteristic functions calculated for the monitoring target building 51 and for each of the air-conditioning machines. Here, the characteristic function calculator 12 stores the characteristic functions in accordance with the kind of the monitoring target building 51 and the kind of characteristic functions.

It is preferable to execute the process by the characteristic function calculator 12 when the monitoring data for a predetermined time period, such as once every month, are accumulated in the monitoring data storage unit 21 of the storage device. The process by the characteristic function calculator 12 may be executed upon request from outside or may be periodically executed at every predetermined time interval. The characteristic functions of the monitoring target building 51 and the respective air-conditioning machines are accumulated in the characteristic data storage unit 22.

The operating condition calculator 13 calculates, by use of the characteristic functions stored in the characteristic data storage unit 22 of the storage device 20, operating condition data to minimize a sum of the amounts of energy consumed by the respective air-conditioning machines. The operating condition calculator 13 extracts the characteristic functions related to the predetermined monitoring target building 51 from the characteristic data storage unit 22 of the storage device 20. The operating condition calculator 13 finds optimum operating conditions with the respective characteristic functions thus extracted being constraints. At this time, an evaluation function J is expressed by the amounts of energy consumed by the respective air-conditioning machines provided in the monitoring target building 51, which the operating condition calculator 13 calculates the operating conditions for. The operating condition data are preferably set up for each of the air-conditioning machines. The operating condition calculator 13 may calculate the operating conditions at given timing such as once every 10 minutes, or upon request from a user and the like.

For example, when the central chiller type air-conditioning system is used, the operating conditions to be calculated by the operating condition calculator 13 include an operating condition of the cooling tower, an operating condition and an amount of water of the central chiller and so forth. The evaluation function J is expressed by J=Σ (the amount of energy consumed by the central chiller+the amount of energy consumed by the air fan+the amount of energy consumed by the chilled water pump+the amount of energy consumed by the cooling water pump+the amount of energy consumed by cooling tower).

Meanwhile, the operating condition calculator 13 may calculate an annual building system COP by use of weather data of the location of the monitoring target building 51. The building system COP is a ratio of an annual amount of energy required for air-conditioning and an annual air-conditioning load. A building having a larger building system COP is evaluated as being air-conditioned efficiently.

An operating condition transmitter 14 transmits the operating condition data determined for the air-conditioning machines of the monitoring target building 51 to the monitoring data collecting apparatus 5 through the communication network 7.

The above-described remote performance monitor 1 according to the embodiment of the present invention acquires the monitoring data concerning the air-conditioning machines in the air-conditioning system of the monitoring target building 51 successively from the monitoring data collecting apparatus 5. When the monitoring data are acquired continuously for a certain time period, the remote performance monitor 1 calculates the characteristic functions and stores the functions in the characteristic data storage unit 22 of the storage device 20. In addition, the monitor 1 determines the optimum operating conditions for the air-conditioning system of the monitoring target building 51 at certain timing based on the characteristic functions stored in the characteristic data storage unit 22 of the storage device 20. Further, the monitor 1 transmits the optimum operating conditions thus determined to the monitoring data collecting apparatus 5 in the monitoring target building 51.

In this way, according to the remote performance monitor 1 of the embodiment of the present invention, it is possible not only to acquire the monitoring data of the monitoring target building 51 but also to determine the optimum operating conditions based on the monitoring data. Hence the remote performance monitor 1 can contribute to energy saving and cost saving of the monitoring target building 51. Meanwhile, in the case of determination of these operating conditions, the remote performance monitor 1 can be managed and administered by an expert. In this way, the remote performance monitor 1 can contribute to operation management of the air-conditioning system in accordance with advices of the expert without deploying an expert to every monitoring target building 51.

### (Remote Monitoring Method)

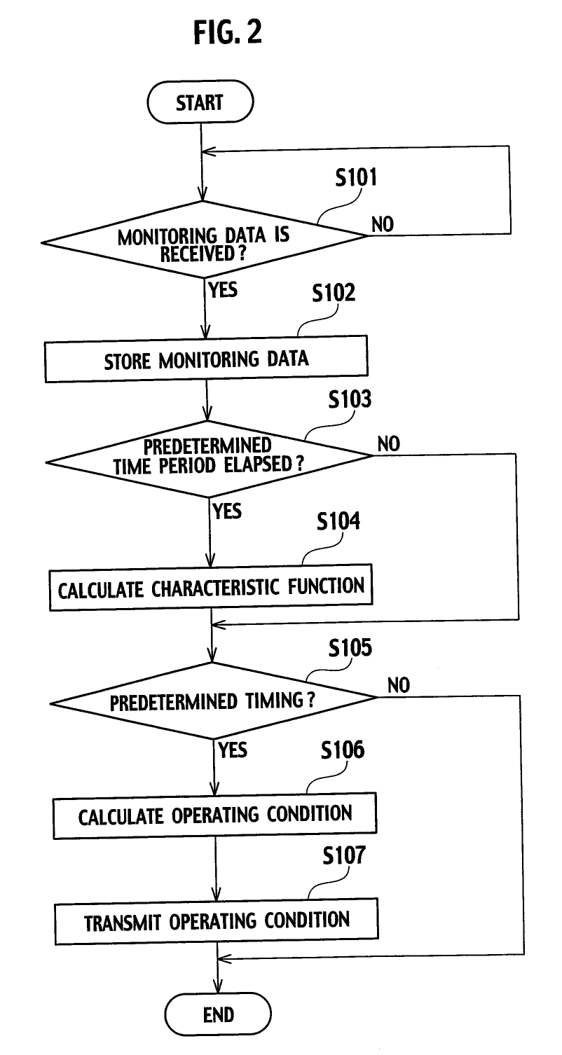

A remote monitoring method according to the embodiment of the present invention will be described with reference to FIG. 2.

First, in Step S101, the monitoring data receiver 11 receives the monitoring data of the air-conditioning machines of the monitoring target building 51 from the monitoring data collecting apparatus 5. In Step S102, the monitoring data receiver 11 stores the monitoring data received in Step S101 in the monitoring data storage unit 22 of the storage device 20.

In Step S103, the characteristic function calculator 12 judges whether or not the monitoring data for a predetermined time period are accumulated in the monitoring data storage unit 21. When a judgment is made that sufficient data are not accumulated therein, the characteristic function calculator 12 does not execute the process and proceeds to Step S105 to judge whether or not it is predetermined timing for calculating the operating conditions. When a judgment is made in Step S103 that the monitoring data for the predetermined time period are accumulated therein, the characteristic function calculator 12 calculates, based on the monitoring data which are stored in the monitoring data storage unit 21 in Step S102, the characteristic functions in Step S104 for the monitoring target building and for each of the air-conditioning machines. The characteristic function calculator 12 stores the characteristic function for each of the air-conditioning machines in the characteristic data storage unit 22 of the storage device 20.

In Step S105, a judgment is made as to whether or not it is predetermined timing for calculating the operating conditions. When a judgment is made that it is not the predetermined timing, the process is finished.

Meanwhile, when a judgment is made in Step S105 that it is the predetermined timing, in Step S106, the operating condition calculator 13 calculates the optimum operating conditions for the air-conditioning system of the monitoring target building 51. In Step S107, the operating condition transmitter 14 transmits the operating conditions calculated in Step S106 to the monitoring data collecting apparatus 5.

FIG. 2 discloses, after receiving monitoring data, the process judges whether predetermined time period elapsed or not (Step S103), and whether it is predetermined timing or not (Step S105). In another embodiment, the process executes receiving monitoring data (Steps S101 and S102), in parallel with calculating characteristic function (Steps S103 and S104) and calculating operating condition (Steps S105 to S107).

### (Central Chiller Type Air-Conditioning System)

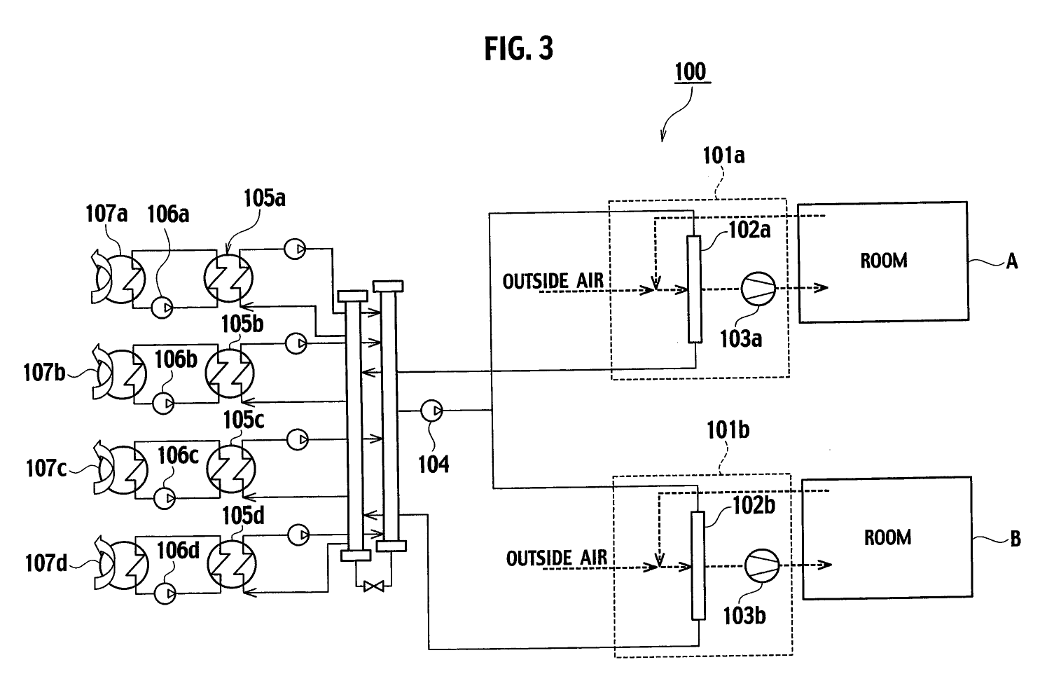

Next, a case where the air-conditioning system of the monitoring target building 51 is of the central chiller type will be described with reference to FIG. 3 to FIG. 5D.

First, a central chiller type air-conditioning system 100 will be described with reference to FIG. 3. The central chiller type air-conditioning system 100 includes air conditioners 101a and 101b, a chilled water pump 104, central chillers 105a, 105b, 105c and 105d, cooling water pumps 106a, 106b, 106c and 106d, and cooling towers 107a, 107b, 107c and 107d.

The air conditioner 101a is an outside air water-air heat exchange type air conditioner installed in a room A. The air conditioner 101a includes a coil 102a and an air fan 103a. The coil 102a cools down, by using the chilled water supplied from the chilled water supply pump, the air supplied by the air fan 103a. The air fan 103a takes in the air in the room A to cool the air with the coil 102a and discharges the cooled air to the room A. The air conditioner 101b also has similar functions to the air conditioner 101a.

The central chiller 105a is a chiller for supplying the chilled water to the coils 102a and 102b of the air conditioners 101a and 101b, respectively. The cooled water is discharged from the central chiller 105a and the returning chilled water, which exchanges heat with the air through the coils 102a and 102b and thereby carries the heat, is taken into the central chiller 105a. The central chillers 105b, 105c and 105d also have similar functions to the central chiller 105a.

The cooling tower 107a is configured to discharge the heat to the outside, which is carried by the returning chilled water that is carried to the central chiller 105a. In the cooling tower 107a, the cooling water is sent to an upper part of the cooling tower 107a with the cooling water pump 106a and is then sprayed over the upper part so as to contact an air flow from a cooling tower fan. With this contact, part of the sprayed cooling water is evaporated so as to lower the temperature of the cooling water. The cooling water at a lower temperature is stored in a tank located lower part and is then circulated again to the system. The cooling towers 107b, 107c and 107d also have similar functions to the cooling tower 107a.

FIG. 3 describes the case of cooling operation of the air-conditioning system. When the air-conditioning system performs heating operation, the cold water is replaced by warm water.

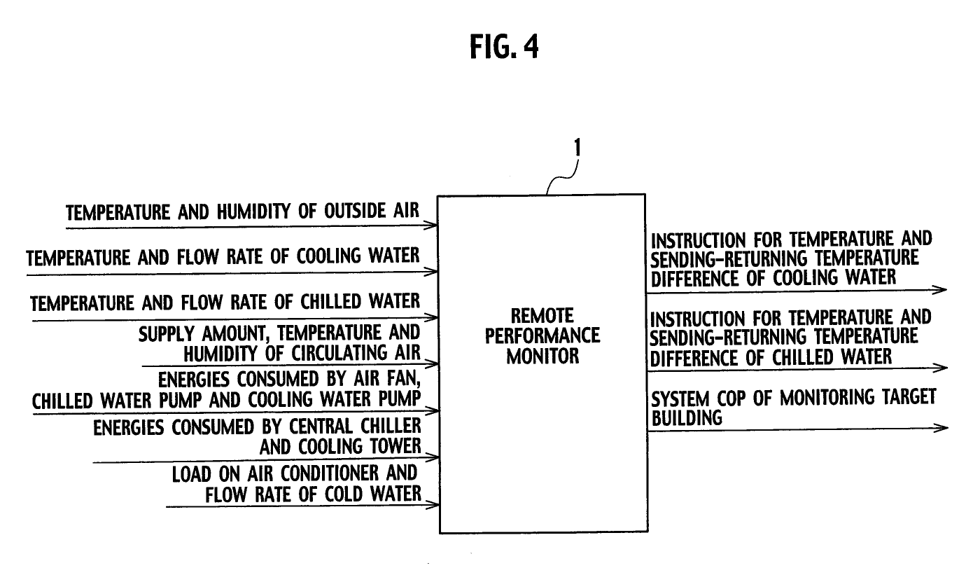

When the monitoring target building 51 has the air-conditioning system shown in FIG. 3, the remote performance monitor 1 transmits and receives data shown in FIG. 4. The monitoring data receiver 11 of the remote performance monitor 1 receives the monitoring data including temperature and humidity of the outside air, temperature and a flow rate of the cooling water, temperature and a flow rate of the cold water, a supply amount, temperature and humidity of circulating air, the amounts of energy consumed by the air fans, the amount of energy consumed by the cold water pump, the amounts of energy consumed by the central chillers, the amounts of energy consumed by the cooling towers, loads on air conditioners and a flow rate of cold water from the monitoring data collecting apparatus 5 in the monitoring target building 51. The operating condition transmitter 14 of the remote performance monitor 1 transmits the operating conditions including instructions for the temperature and an sending-returning temperature difference of the cooling water, instructions for the temperature and an sending-returning temperature difference of the chilled water and the system COP of the monitoring target building to the monitoring data collecting apparatus 5 in the monitoring target building 51.

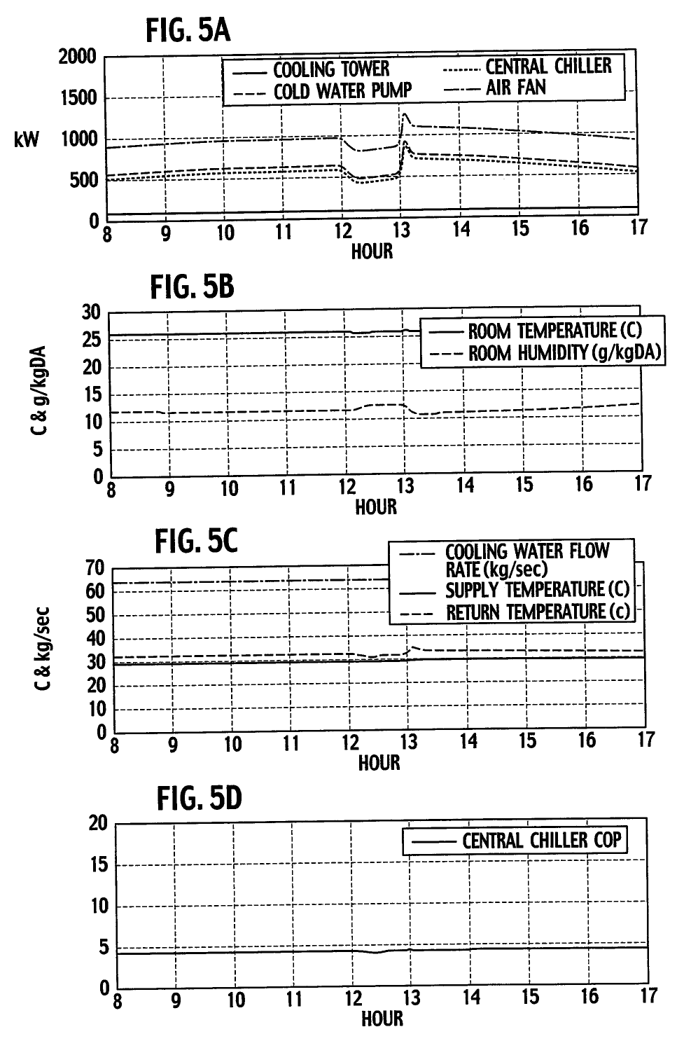

Now, examples of the data to be received by the monitoring data receiver 11 of the remote performance monitor 1 will be described with reference to FIGS. 5A to 5D. FIGS. 5A to 5D show the respective monitoring data that are sequentially transmitted in chronological order. FIG. 5A is a graph showing the power consumption by the air-conditioning machines, namely, the cooling tower, the cooling water pump, the central chiller, and the air fan. FIG. 5B is a graph showing indoor temperature and indoor humidity of a room where the air-conditioner is installed. FIG. 5C is a graph showing the flow rate and the temperature of the cooling water and the temperature of the cooling water returning to the cooling tower. FIG. 5D is a graph showing the COP of the central chiller.

When the monitoring data receiver 11 of the remote performance monitor 1 receives the data as described above, the characteristic function calculator 12 calculates a function of an air-conditioning load on the monitoring target building 51 relative to the outside air temperature and the outside air humidity as the characteristic function of the monitoring target building 51. Here, the air-conditioning load is data received by the monitoring data receiver 11 of the remote performance monitor 1. Alternatively, the air-conditioning load may be calculated by the remote performance monitor 1 based on the data received by the monitoring data receiver 11.

Further, the characteristic function calculator 12 of the remote performance monitor 1 calculates the following functions for each of the air-conditioning machines in the air-conditioning system. Note that the characteristic function calculator 12 may also calculate functions other than the functions described below:

### (1) Concerning the Central Chiller

a function of an efficiency COP of the central chiller in terms of the chilled water temperature of the chilled water produced by the central chiller, the flow rate of the chilled water, the cooling water temperature of the cooling water and the flow rate of the cooling water, and chilling capacity;

### (2) Concerning the Cooling Tower

a function of heat exchange efficiency in terms of the temperature of the outside air, the humidity of the outside air, the cooling water temperature of the cooling water returning to the cooling tower and the flow rate of the cooling water;

### (3) Concerning the Air-Conditioner (the Coil)

a function of an overall heat transmission rate in terms of an amount of the chilled water in the air-conditioner, an air flow rate, temperature of the air and humidity of the air;

### (4) Concerning the Air-Conditioner (the Air Fan)

a function between the amount of energy consumed by the air fan and the air-conditioning load or air flow rate;

### (5) Concerning the Chilled Water Pump

a function between the chilled water pump and the flow rate of the chilled water (excluding bypass); and

### (6) Concerning the Cooling Water Pump

a function between the cooling water pump and the flow rate of the cooling water.

The characteristic function calculator 12 approximates each function by f=ax+b or f=ax²+ax+b and outputs the approximated functions as the characteristic functions, respectively.

The operating condition calculator 13 calculates the optimum operating conditions. Here, the operating condition calculator 13 adjusts the air-conditioning load with the characteristic functions outputted from the characteristic function calculator 12 being the constraints. The operating condition calculator 13 outputs, as the optimum operating conditions, the operating conditions to minimize the sum of the amounts of energy consumed by the respective air-conditioning machines.

The operating conditions to be calculated by the operating condition calculator 13 include the operating condition of the cooling tower, the operating condition of the central chiller and the amount of water. The evaluation function J is expressed by J=Σ (the amount of energy consumed by the central chiller+the amount of energy consumed by the air fan+the amount of energy consumed by the chilled water pump+the amount of energy consumed by the cooling water pump+the amount of energy consumed by cooling tower).

Moreover, when calculating and evaluating the annual building system COP, the operating condition calculator 13 performs evaluation by using, of the monitoring target building 51, the above-described function of the air-conditioning load and the meteorological data of the location, the function relating the temperature and the humidity of the outside air, Though the annual building system COP thus calculated varies according to the state of utilization such as weather in a particular year or on a tenant occupancy rate of the building, in reality, this annual building system COP is deemed as the evaluation value calculated by acquiring the actual data for one year.

### (Multi Packaged Type Air-Conditioner System)

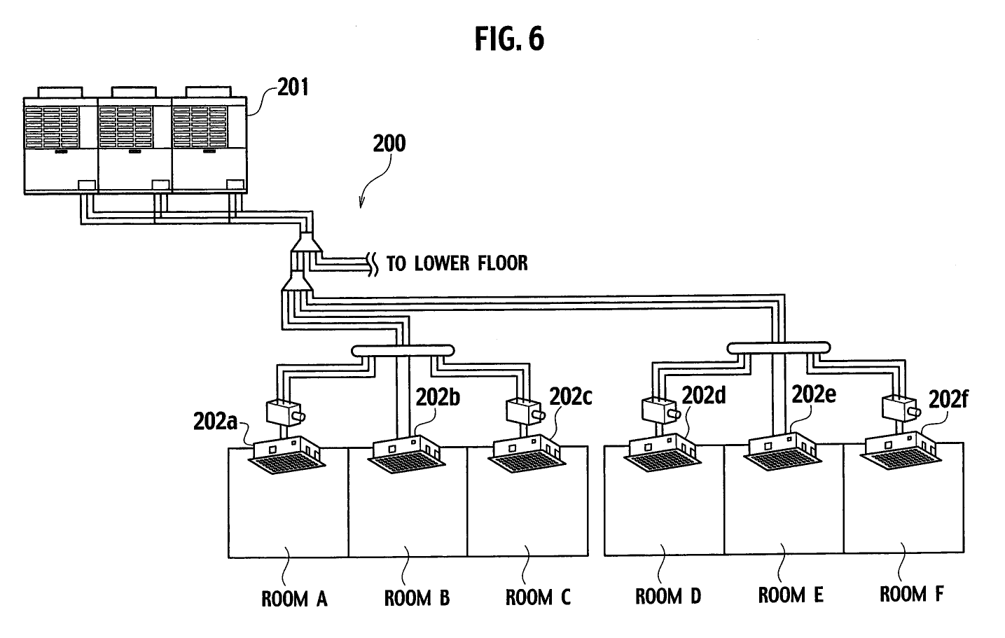

A case where the air-conditioning system of the monitoring target building 51 is of the multi packaged type air-conditioner will be described with reference to FIG. 6 to FIG. 8.

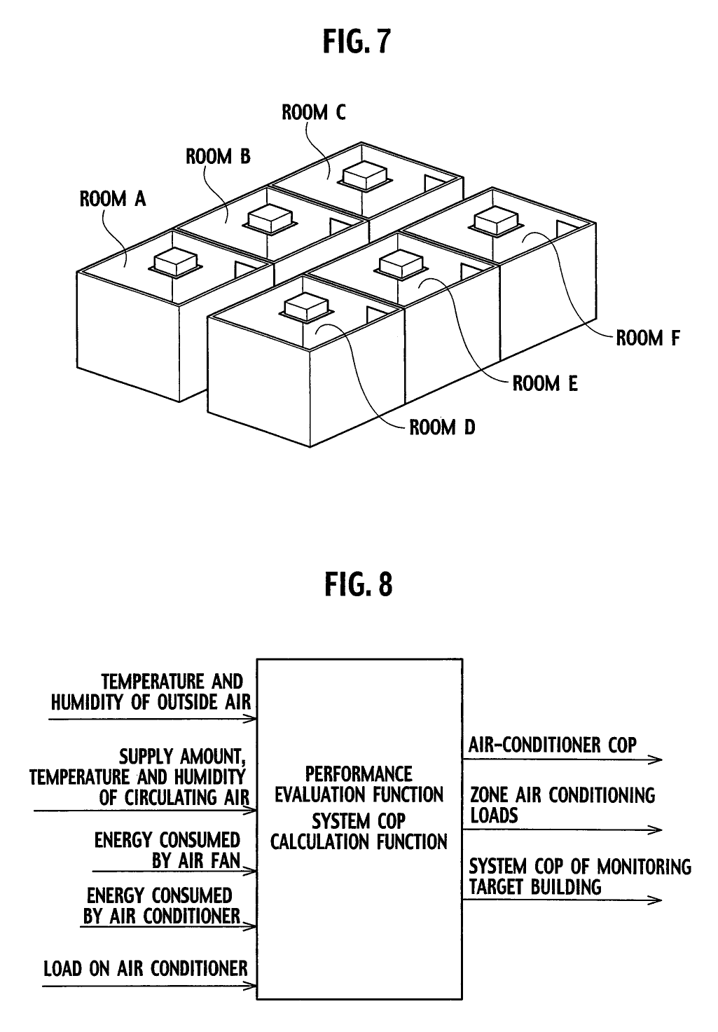

First, a multi packaged type air-conditioner 200 will be described with reference to FIG. 6. The multi packaged type air-conditioner system 200 includes an outdoor unit 201, and indoor units 202a, 202b, 202c, 202d, 202e and 202f. The outdoor unit 201 deals with heat loads on the respective indoor units in a lump. In the example shown in FIG. 6, rooms constituting zones subject to air-conditioning control by the indoor unit 202a are arranged as shown in FIG. 7. The indoor unit 202a is installed in a room A and controls air-conditioning of the room A by operation of the outdoor unit. The indoor units 202b, 202c, 202d, 202e and 202f also have similar configurations to the indoor unit 202a.

When the monitoring target building 51 has the air-conditioning system as shown in FIG. 6, the remote performance monitor 1 transmits and receives data shown in FIG. 8. The monitoring data receiver 11 of the remote performance monitor 1 receives the monitoring data including the temperature and the humidity of the outside air, the supply amount, the temperature and the humidity of the circulating air, the amounts of energy consumed by the air fans, the amounts of energy consumed by the air-conditioners and loads on the air conditioners from the monitoring data collecting apparatus 5 in the monitoring target building 51. The operating condition transmitter 14 of the remote performance monitor 1 transmits the operating conditions including air-conditioner COP, the air-conditioner loads for the respective zones and the system COP of the monitoring target building 51 to the monitoring data collecting apparatus 5 in the monitoring target building 51.

When the monitoring data receiver 11 of the remote performance monitor 1 receives the data as described above, the characteristic function calculator 12 calculates, as the characteristic function of the monitoring target building 51, a function of an air-conditioning load on the monitoring target building 51 relative to the outside air temperature and the outside air humidity. Here, the air-conditioning load is data received by the monitoring data receiver 11 of the remote performance monitor 1. Alternatively, the air-conditioning load may be calculated by the remote performance monitor 1 based on the data received by the monitoring data receiver 11.

Further, the characteristic function calculator 12 of the remote performance monitor 1 calculates the following functions for each of the air-conditioning system. Note that the characteristic function calculator 12 may also calculate functions other than the functions described below:

### (1) Concerning the Air-Conditioner Including the Outdoor Unit and the Indoor Unit

a COP function of the air-conditioner in terms of the outside air temperature and an indoor load; and

### (2) Concerning the Indoor Unit

a function of the overall heat transmission rate of the air-conditioner in terms of the flow rate of the refrigerant in the air-conditioner, the air flow rate, the temperature of the air and the humidity of the air.

Here, the indoor load is the air-conditioning load in the zone which is air-conditioned by a specific air-conditioner, which is similar to the air-conditioner load.

The operating condition calculator 13 calculates the optimum operating conditions. Here, the operating condition calculator 13 adjusts the temperature, the pressure, or the flow rate of refrigerant in the indoor unit with the characteristic functions outputted from the characteristic function calculator 12 being the constraints, and outputs as the optimum operating conditions the operating conditions to minimize the sum of the amounts of energy consumed by the respective air-conditioning machines.

The operating conditions to be calculated by the operating condition calculator 13 include air-conditioning COP and a zone air-conditioning load. The evaluation function J is expressed by J=Σ (the amount of energy consumed by the outdoor unit+the amounts of energy consumed by the indoor units).

Moreover, when calculating and evaluating the annual building system COP, evaluation is executed by using, of the monitoring target building 51, the above-described function of the air-conditioning load and the meteorological data of the location, the function relating the temperature and the humidity of the outside air. Though the annual building system COP thus calculated varies depending on the state of utilization such as weather in a particular year or on the tenant occupancy rate of the building in reality, this annual building system COP is deemed as the evaluation value calculated by acquiring the actual data for one year.

According to the remote performance monitor 1 of the embodiment of the present invention, it is possible not only to acquire the monitoring data of the monitoring target building 51 but also to determine the optimum operating conditions based on the monitoring data. Hence the remote performance monitor 1 can contribute to energy saving and cost saving of the monitoring target building 51.

Meanwhile, in the case of determination of these operating conditions, the remote performance monitor 1 is managed and administered by an expert, and is thereby able to contribute to operation management of the air-conditioning system in accordance with advices of the expert without deploying an expert to every monitoring target building 51. Therefore, according to the remote performance monitor 1 of the embodiment of the present invention, it is possible to manage the air-conditioning machines in the building more efficiently than processing the information for each of the monitoring target buildings 51 separately.

### OTHER EMBODIMENTS

As described above, while the present invention has been described in terms of the embodiments of the present invention, the present invention should not be limited to the description and drawings as part of the disclosure. Various alternative embodiments, practical applications and implementations will be apparent to those skilled in the art from the disclosure.

For example, as for the characteristic function in each of the air-conditioning systems, it is preferable to select an appropriate characteristic function according to the type of the air-conditioning system or the characteristic of the monitoring target building.

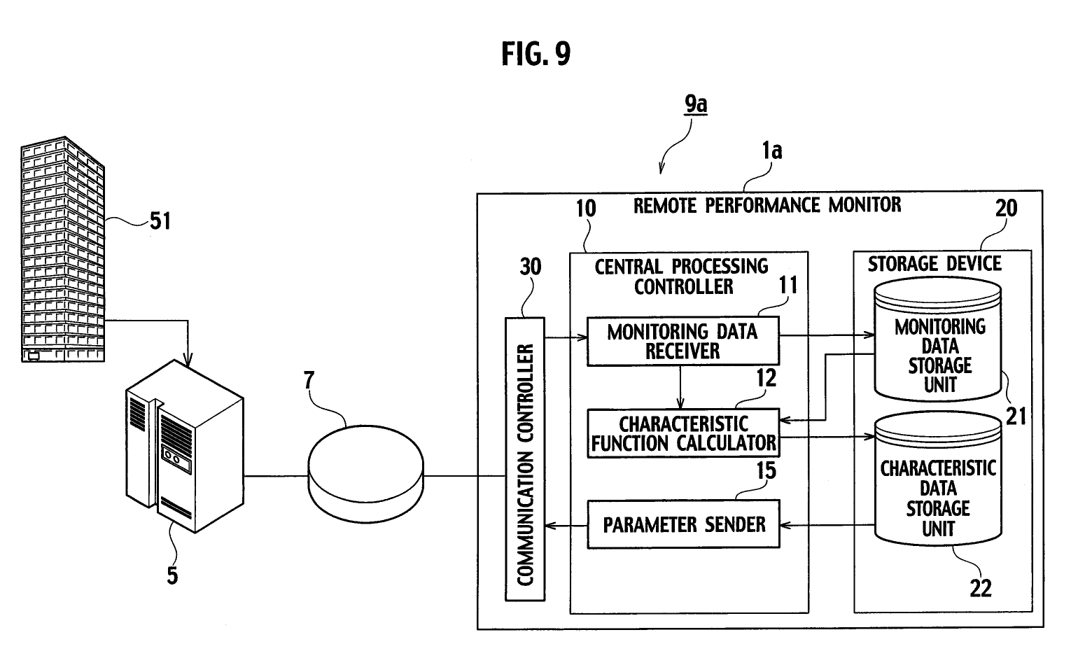

As shown FIG. 9, the remote performance monitor 1a can include a parameter sender instead of operating condition calculator 13 and operating condition transmitter 14. The parameter sender sends parameters of the characteristic function, which is calculated by the characteristic function calculator 12. The monitoring data collecting apparatus 5 receives the parameters of the characteristic function to calculate operating condition data by the air-conditioning machines by using parameters of the characteristic function.

Various modifications will become possible for those skilled in the art after receiving the teachings of the present disclosure without departing from the scope thereof.

### BACKGROUND OF THE INVENTION

1. Field of the Invention

The present invention relates to a remote performance monitor and a remote performance monitoring method configured to acquire monitoring data concerning an air-conditioning system of a monitoring target building and to determine an operating condition of the air-conditioning system.

2. Description of the Related Art

Numerous techniques have heretofore been disclosed concerning remote monitoring, which is to monitor a monitoring target device from a place away from a site where the monitoring target device is installed. The techniques concerning this remote monitoring have also been applied to the purpose of monitoring building facilities such as an air-conditioning system.

Along the development in the communication technology, there has been a technique to acquire necessary signals from an air-conditioning system and to transmit the signals to a remote monitoring center in the distance. In the past, it was necessary to send an expert to each building in order to attend monitoring on site. However, according to this technique, it is possible to monitor numerous air-conditioning systems located in many places with a small number of experts at any time. Hence many advantages are obtained from this technique.

One of the techniques concerning remote monitoring is a remote monitoring method applying two communication lines installed in parallel in order to ensure compatibility between a proprietary communication protocol defined by a manufacturer and a de facto standard communication protocol (see Japanese Patent Application Publication No. 2005-274125, for example). Japanese Patent Application Publication No. 2005-274125 discloses a method of remotely monitoring an air conditioner by installing two communication lines in parallel.

Meanwhile, there is an apparatus configured to monitor a condition of a building by use of data acquired by remote monitoring (see Japanese Patent Application Publication No. 2005-182441, for example). An analyzer apparatus for building facility management disclosed in this Japanese Patent Application Publication No. 2005-182441 includes a communication interface, an analytical data collector-processor, an inference rule storage unit, an inference unit and an output unit. The communication interface receives a communication signal containing information necessary for managing an operating condition of a facility installed in a building. The analytical data collector-processor extracts the information out of the received communication signal and stores the information in an analytical data storage unit. The inference rule storage unit stores an inference process program in advance, which is configured to infer a cause of unachieved management objective when the operating condition of the facility does not reach the management objective condition thereof. The inference unit analyzes the information in accordance with the inference process program and thereby infers the cause. The output unit displays a result of inference by the inference unit. In this way, the cause of unachieved management objective is inferred when the operating condition of the facility does not reach the management objective condition.

Meanwhile, a conventional air-conditioning system has poor accuracy caused by handling a fluid. Accordingly, the conventional air-conditioning system had problems of disabilities to detect a predictor of breakdown, to absorb individual differences among actual machines in a breakdown judgment and to judge the cause of the breakdown. To solve these problems, there has been disclosed the following fluid circuit diagnosis method (see Japanese Patent Application Publication No. 2005-351618). In this method, firstly detected are multiple measured amounts, such as pressure, temperature and other factors of a coolant for a refrigeration cycle apparatus or the like. Then, by use of these measured amounts, a state quantity such as a composite variable is calculated. Finally, it is judged, from the result of the calculation, whether or not the apparatus is normal. In the method disclosed in Japanese Patent Application Publication No. 2005-351618, the current state of the refrigeration cycle apparatus is allowed to be judged by learning state of normal operation. Moreover, in the method disclosed in Japanese Patent Application Publication No. 2005-351618, a breakdown such as an operating limit is allowed to be predicted from variation in the Mahalanobis' generalized distance by learning the state of the apparatus forcedly performing abnormal operation, or by calculating an abnormal operating state at the time of current operation. Accordingly, Japanese Patent Application Publication No. 2005-351618 discloses a solution involving achievement of reliable diagnosis with a simple configuration, which has a large effect for remote monitoring for abnormalities in the distance.

As described above, the conventional techniques have achieved the apparatuses with functions for sending and receiving basic signals for exchanging signals to achieve remote monitoring. The technique disclosed in Japanese Patent Application Publication No. 2005-351618 further achieves a logical function for judging whether a monitoring target facility is in normal state.

However, the above-described conventional techniques are merely able to achieve detection of a breakdown of a facility by means of remote monitoring and have not been able to achieve support in operation appropriately in response to specifications of respective facilities. For example, constructions such as buildings have various conditions including locations, sizes, structures, capacities, and so forth. It is therefore important in light of cost saving and energy saving to conduct the optimum operations while considering various conditions of the constructions.

### SUMMARY OF THE INVENTION

It therefore is an object of the present invention to provide a remote performance monitor and a remote performance monitoring method which support an appropriate operation of an air-conditioning system of a building considering a condition of the building.

According to an aspect of the present invention, a remote performance monitor configured to acquire monitoring data concerning an air-conditioning system of a monitoring target building and to determine an operating condition of the air-conditioning system, the remote performance monitor comprises a monitoring data receiver which receives monitoring data from a monitoring data collecting apparatus in the monitoring target building, wherein the monitoring data is data concerning performance characteristics of air-conditioning machines installed in the air-conditioning system of the monitoring target building, a characteristic function calculator which calculates a characteristic function for the monitoring target building and for each of the air-conditioning machines based on the monitoring data and an operating condition calculator which calculates operating condition data to minimize a sum of amounts of energy consumed by the air-conditioning machines by using the characteristic function.

According to the other aspect of the present invention, a remote performance monitoring method configured to acquire monitoring data concerning an air-conditioning system of a monitoring target building and to determine an operating condition of the air-conditioning system, the remote performance monitoring method comprises receiving monitoring data from a monitoring data collecting apparatus in the monitoring target building, wherein the monitoring data is data concerning performance characteristics of air-conditioning machines installed in the air-conditioning system of the monitoring target building, calculating a characteristic function for the monitoring target building and for each of the air-conditioning machines based on the monitoring data; and calculating operating condition data to minimize the sum of amounts of energy consumed by the air-conditioning machines by using the characteristic function.

According to the other aspect of the present invention, a remote performance monitor configured to acquire monitoring data concerning an air-conditioning system of a monitoring target building and to determine an operating condition of the air-conditioning system, the remote performance monitor comprises a monitoring data receiver configured to receive monitoring data from a monitoring data collecting apparatus in the monitoring target building, wherein the monitoring data is data concerning performance characteristics of air-conditioning machines installed in the air-conditioning system of the monitoring target building, a characteristic function calculator configured to calculate a characteristic function for the monitoring target building and for each of the air-conditioning machines based on the monitoring data and a parameter sender configured to send parameters of the characteristic function which is calculated by the characteristic function calculator.

According to the other aspect of the present invention, a remote performance monitoring method configured to acquire monitoring data concerning an air-conditioning system of a monitoring target building and to determine an operating condition of the air-conditioning system, the remote performance monitoring method comprises receiving monitoring data from a monitoring data collecting apparatus in the monitoring target building, wherein the monitoring data is data concerning performance characteristics of air-conditioning machines installed in the air-conditioning system of the monitoring target building, calculating a characteristic function for the monitoring target building and for each of the air-conditioning machines based on the monitoring data and sending parameters of the characteristic function which is calculated by the calculating step.

### BRIEF DESCRIPTION OF DRAWINGS

FIG. 1 is a view for explaining a system configuration of a remote performance monitoring system and functional blocks of a remote performance monitor according to an embodiment of the present invention.

FIG. 2 is a flowchart for explaining a process to be executed by the remote performance monitoring system according to the embodiment of the present invention.

FIG. 3 is a view for explaining an example of a general central chiller type air-conditioning system.

FIG. 4 is a view for explaining input and output data in the case of applying the remote performance monitor according to the embodiment of the present invention to the central chiller type air-conditioning system.

FIG. 5A is an example of monitoring data to be received by the remote performance monitoring system according to the embodiment of the present invention, which is the example of monitoring data concerning power consumption.

FIG. 5B is an example of monitoring data to be received by the remote performance monitoring system according to the embodiment of the present invention, which is the example of monitoring data concerning room conditions.

FIG. 5C is an example of monitoring data to be received by the remote performance monitoring system according to the embodiment of the present invention, which is the example of monitoring data concerning cooling water.

FIG. 5D is an example of monitoring data to be received by the remote performance monitoring system according to the embodiment of the present invention, which is the example of monitoring data concerning COP (coefficient of performance).

FIG. 6 is a view for explaining an example of a general multi packaged type air-conditioner system.

FIG. 7 is a view for explaining an installation example of indoor units in the case of the general multi packaged type air-conditioner system.

FIG. 8 is a view for explaining input and output data in the case of applying the remote performance monitor according to the embodiment of the present invention to the multi packaged type air-conditioner system.

FIG. 9 is a view for explaining a system configuration of a remote performance monitoring system and functional blocks of a remote performance monitor according to another embodiment of the present invention.

### DETAILED DESCRIPTION OF THE INVENTION

### (Remote Performance Monitoring System)

FIG. 1 is a system configuration view of a remote performance monitoring system 9 according to an embodiment of the present invention. The remote performance monitoring system 9 includes a monitoring target building 51, a monitoring data collecting apparatus 5, and a remote performance monitor 1. The monitoring data collecting apparatus 5 monitors the monitoring target building 51. In FIG. 1, the remote performance monitoring system 9 includes the single monitoring target building 51 and the single monitoring data collecting apparatus 5. Alternatively, the remote performance monitoring system 9 may include multiple monitoring target buildings 51 and multiple monitoring data collecting apparatuses 5. The monitoring data collecting apparatus 5 and the remote performance monitor 1 are mutually connected trough a communication network 7 such as the internet.

The monitoring target building 51 includes air-conditioning machines concerning air-conditioning. When the monitoring target building 51 uses a central chiller type air-conditioning system, the air-conditioning machine includes more than one central chiller, more than one cooling tower, more than one air conditioner, more than one cool water pump, more than one cooling water pump, more than one air fan. When the monitoring target building 51 is a multi packaged type air-conditioner includes air conditioners such as outdoor unit and indoor unit. The air-conditioning system of the monitoring target building 51 will be described later in detail.

The monitoring data collecting apparatus 5 is, for example, information equipment installed inside the monitoring target building 51. The monitoring data collecting apparatus 5 is connected electrically to each air-conditioning machine provided therein. The monitoring data collecting apparatus 5 collects monitoring data indicating performance characteristics of the air-conditioning machines from the respective air-conditioning machines in the monitoring target building 51, and transmits the data to the remote performance monitor 1. The monitoring data are the data measured by the respective air-conditioning machines in the monitoring target building 51. The monitoring data include data concerning performance characteristics as well as energy consumption of the respective air-conditioning machines. For example, when the air-conditioning machine is the central chiller, the monitoring data include a chilled water temperature of chilled water produced by the central chiller, a flow rate of the chilled water, a cooling water temperature of cooling water taken into the central chiller, and a flow rate of the cooling water. Further, the monitoring data collecting apparatus 5 receives operating conditions of the respective air-conditioning machines from the remote performance monitor 1. These operating conditions are outputted from the remote performance monitor 1 based on the monitoring data. The monitoring data collecting apparatus 5 may determine settings of the respective air-conditioning machines of the monitoring target building 51 by making reference to the received operating conditions. Moreover, the monitoring data collecting apparatus 5 may include a function to apply the received operating conditions to operating conditions of the respective air-conditioning machines installed in the monitoring target building 51.

The remote performance monitor 1 acquires the monitoring data concerning the air-conditioning system of the monitoring target building 51 and determines operating conditions of the air-conditioning system. To be more precise, the remote performance monitor 1 determines, based on the monitoring data received from the monitoring data collecting apparatus 7, performance characteristics of the monitoring target building 51 and of the respective air-conditioning machines in the monitoring target building 51. Moreover, the remote performance monitor 1 determines, on the basis of the respective performance characteristics thus determined, the operating conditions of the respective air-conditioning machines so as to optimize energy efficiency in the air-conditioning system in the monitoring target building 51. The remote performance monitor 1 transmits the determined operating conditions to the monitoring data collecting apparatus 7.

### (Remote Performance Monitor)

Next, the remote performance monitor 1 according to the embodiment of the present invention will be described in detail with reference to FIG. 1.

The remote performance monitor 1 includes a central processing controller 10, a storage device 20 and a communication controller 30. In addition, the remote performance monitor 1 further includes various other devices such as a ROM, a RAM or a bus. The central processing controller 10 controls processes to be executed by the remote performance monitor 1. The storage device 20 stores data used in the course of processes by the central processing controller 10 and data representing process results. The communication controller 30 is the device to be an interface for establishing connection between the remote performance monitor 1 and the communication network 7.

A monitoring data receiver 11, a characteristic function calculator 12, an operating condition calculator 13, and an operating condition transmitter 14 are implemented on the central processing controller 10 by installing a remote characteristic monitoring program on the remote performance monitor 1. The storage device 20 includes a monitoring data storage unit 21 and a characteristic data storage unit 22.

The monitoring data receiver 11 receives monitoring data concerning performance characteristics of the respective air-conditioning machines installed in the air-conditioning system of the monitoring target building 51 from the monitoring data collecting apparatus 52 of the monitoring target building 51. Here, the performance characteristic is index for evaluating performance of the air-conditioning machine installed in the air-conditioning system of the monitoring target building 51. The performance characteristics may be set up depending on the type of the air-conditioning system or individually for each of the air-conditioning machines.

The monitoring data receiver 11 receives the monitoring data from the monitoring data collecting apparatus 5 through the communication network 7 and the communication controller 30. The monitoring data receiver 11 may acquire the monitoring data from the monitoring data collecting apparatus 5 by sending a request concerning acquisition of the monitoring data to the monitoring data collecting apparatus 5. Alternatively, the monitoring data receiver 11 may receive the monitoring data by causing the monitoring data collecting apparatus 5 to transmit the monitoring data periodically to the remote performance monitor 1. The monitoring data receiver 11 may receive the monitoring data for each of multiple monitoring target buildings 51 from multiple monitoring data collecting apparatuses 5.

The monitoring data receiver 11 stores the received monitoring data in the monitoring data storage unit 21 of the storage device 20. Here, the monitoring data receiver stores, in the monitoring data storage unit 21, the monitoring data associated with an identifier of the monitoring building 51, received date and the like.

The characteristic function calculator 12 calculates a characteristic function for the monitoring target building 51 and for each of the air-conditioning machines provided in the monitoring target building 51. The characteristic function calculator 12 calculates the characteristic function indicating the performance characteristic of the monitoring target building 51 and calculates the characteristic functions indicating the performance characteristics of the respective air-conditioning machines. The characteristic function for each of the air-conditioning machines is a function of machine characteristic which varies depending on deterioration or other factors of the air-conditioning machine, for example. The characteristic function calculator 12 finds the characteristic functions based on the acquired monitoring data when the monitoring data receiver 11 accumulates the monitoring data for a predetermined time period in the monitoring data storage unit 21.

In order to find the characteristic function, there are a method of finding an optimal solution by using rigorous mathematical programming and a method of finding a linear algebraic equation by linear approximation of the characteristic of each of the air-conditioning machines and outputting the linear algebraic equation as a specific function.

Here, a method of finding the specific function by use of the linear algebraic equation will be described. When finding the specific function for the central chiller in the air-conditioning system of the monitoring target building 51, for example, the characteristic function calculator 12 approximates a COP (coefficient of performance; here, energy consumption efficiency) of the central chiller according to the monitoring data, which are received by the monitoring data receiver 11, by a linear function f=ax+b. Here, the COP is a value expressing cooling or heating power for 1 kW of power consumption. The parameter x is a vector containing such elements as the temperature of the chilled water produced by the central chiller, the flow rate of the chilled water, the temperature of the cooling water taken into the central chiller, or the flow rate of the cooling water. The characteristic function calculator 12 outputs this linear function f=ax+b as the characteristic function of the central chiller.

The characteristic function calculator 12 stores, as characteristic data, in the characteristic data storage unit 22 in the storage device 20, the information concerning characteristic functions calculated for the monitoring target building 51 and for each of the air-conditioning machines. Here, the characteristic function calculator 12 stores the characteristic functions in accordance with the kind of the monitoring target building 51 and the kind of characteristic functions.

It is preferable to execute the process by the characteristic function calculator 12 when the monitoring data for a predetermined time period, such as once every month, are accumulated in the monitoring data storage unit 21 of the storage device. The process by the characteristic function calculator 12 may be executed upon request from outside or may be periodically executed at every predetermined time interval. The characteristic functions of the monitoring target building 51 and the respective air-conditioning machines are accumulated in the characteristic data storage unit 22.

The operating condition calculator 13 calculates, by use of the characteristic functions stored in the characteristic data storage unit 22 of the storage device 20, operating condition data to minimize a sum of the amounts of energy consumed by the respective air-conditioning machines. The operating condition calculator 13 extracts the characteristic functions related to the predetermined monitoring target building 51 from the characteristic data storage unit 22 of the storage device 20. The operating condition calculator 13 finds optimum operating conditions with the respective characteristic functions thus extracted being constraints. At this time, an evaluation function J is expressed by the amounts of energy consumed by the respective air-conditioning machines provided in the monitoring target building 51, which the operating condition calculator 13 calculates the operating conditions for. The operating condition data are preferably set up for each of the air-conditioning machines. The operating condition calculator 13 may calculate the operating conditions at given timing such as once every 10 minutes, or upon request from a user and the like.

For example, when the central chiller type air-conditioning system is used, the operating conditions to be calculated by the operating condition calculator 13 include an operating condition of the cooling tower, an operating condition and an amount of water of the central chiller and so forth. The evaluation function J is expressed by J=Σ (the amount of energy consumed by the central chiller+the amount of energy consumed by the air fan+the amount of energy consumed by the chilled water pump+the amount of energy consumed by the cooling water pump+the amount of energy consumed by cooling tower).

Meanwhile, the operating condition calculator 13 may calculate an annual building system COP by use of weather data of the location of the monitoring target building 51. The building system COP is a ratio of an annual amount of energy required for air-conditioning and an annual air-conditioning load. A building having a larger building system COP is evaluated as being air-conditioned efficiently.

An operating condition transmitter 14 transmits the operating condition data determined for the air-conditioning machines of the monitoring target building 51 to the monitoring data collecting apparatus 5 through the communication network 7.

The above-described remote performance monitor 1 according to the embodiment of the present invention acquires the monitoring data concerning the air-conditioning machines in the air-conditioning system of the monitoring target building 51 successively from the monitoring data collecting apparatus 5. When the monitoring data are acquired continuously for a certain time period, the remote performance monitor 1 calculates the characteristic functions and stores the functions in the characteristic data storage unit 22 of the storage device 20. In addition, the monitor 1 determines the optimum operating conditions for the air-conditioning system of the monitoring target building 51 at certain timing based on the characteristic functions stored in the characteristic data storage unit 22 of the storage device 20. Further, the monitor 1 transmits the optimum operating conditions thus determined to the monitoring data collecting apparatus 5 in the monitoring target building 51.

In this way, according to the remote performance monitor 1 of the embodiment of the present invention, it is possible not only to acquire the monitoring data of the monitoring target building 51 but also to determine the optimum operating conditions based on the monitoring data. Hence the remote performance monitor 1 can contribute to energy saving and cost saving of the monitoring target building 51. Meanwhile, in the case of determination of these operating conditions, the remote performance monitor 1 can be managed and administered by an expert. In this way, the remote performance monitor 1 can contribute to operation management of the air-conditioning system in accordance with advices of the expert without deploying an expert to every monitoring target building 51.

### (Remote Monitoring Method)

A remote monitoring method according to the embodiment of the present invention will be described with reference to FIG. 2.

First, in Step S101, the monitoring data receiver 11 receives the monitoring data of the air-conditioning machines of the monitoring target building 51 from the monitoring data collecting apparatus 5. In Step S102, the monitoring data receiver 11 stores the monitoring data received in Step S101 in the monitoring data storage unit 22 of the storage device 20.

In Step S103, the characteristic function calculator 12 judges whether or not the monitoring data for a predetermined time period are accumulated in the monitoring data storage unit 21. When a judgment is made that sufficient data are not accumulated therein, the characteristic function calculator 12 does not execute the process and proceeds to Step S105 to judge whether or not it is predetermined timing for calculating the operating conditions. When a judgment is made in Step S103 that the monitoring data for the predetermined time period are accumulated therein, the characteristic function calculator 12 calculates, based on the monitoring data which are stored in the monitoring data storage unit 21 in Step S102, the characteristic functions in Step S104 for the monitoring target building and for each of the air-conditioning machines. The characteristic function calculator 12 stores the characteristic function for each of the air-conditioning machines in the characteristic data storage unit 22 of the storage device 20.

In Step S105, a judgment is made as to whether or not it is predetermined timing for calculating the operating conditions. When a judgment is made that it is not the predetermined timing, the process is finished.

Meanwhile, when a judgment is made in Step S105 that it is the predetermined timing, in Step S106, the operating condition calculator 13 calculates the optimum operating conditions for the air-conditioning system of the monitoring target building 51. In Step S107, the operating condition transmitter 14 transmits the operating conditions calculated in Step S106 to the monitoring data collecting apparatus 5.

FIG. 2 discloses, after receiving monitoring data, the process judges whether predetermined time period elapsed or not (Step S103), and whether it is predetermined timing or not (Step S105). In another embodiment, the process executes receiving monitoring data (Steps S101 and S102), in parallel with calculating characteristic function (Steps S103 and S104) and calculating operating condition (Steps S105 to S107).

### (Central Chiller Type Air-Conditioning System)

Next, a case where the air-conditioning system of the monitoring target building 51 is of the central chiller type will be described with reference to FIG. 3 to FIG. 5D.

First, a central chiller type air-conditioning system 100 will be described with reference to FIG. 3. The central chiller type air-conditioning system 100 includes air conditioners 101a and 101b, a chilled water pump 104, central chillers 105a, 105b, 105c and 105d, cooling water pumps 106a, 106b, 106c and 106d, and cooling towers 107a, 107b, 107c and 107d.

The air conditioner 110a is an outside air water-air heat exchange type air conditioner installed in a room A. The air conditioner 101a includes a coil 102a and an air fan 103a. The coil 102a cools down, by using the chilled water supplied from the chilled water supply pump, the air supplied by the air fan 103a. The air fan 103a takes in the air in the room A to cool the air with the coil 102a and discharges the cooled air to the room A. The air conditioner 101b also has similar functions to the air conditioner 101a.

The central chiller 105a is a chiller for supplying the chilled water to the coils 102a and 102b of the air conditioners 111a and 101b, respectively. The cooled water is discharged from the central chiller 105a and the returning chilled water, which exchanges heat with the air through the coils 102a and 102b and thereby carries the heat, is taken into the central chiller 105a. The central chillers 105b, 105c and 105d also have similar functions to the central chiller 105a.

The cooling tower 107a is configured to discharge the heat to the outside, which is carried by the returning chilled water that is carried to the central chiller 105a. In the cooling tower 107a, the cooling water is sent to an upper part of the cooling tower 107a with the cooling water pump 106a and is then sprayed over the upper part so as to contact an air flow from a cooling tower fan. With this contact, part of the sprayed cooling water is evaporated so as to lower the temperature of the cooling water. The cooling water at a lower temperature is stored in a tank located lower part and is then circulated again to the system. The cooling towers 107b, 107c and 107d also have similar functions to the cooling tower 107a.

FIG. 3 describes the case of cooling operation of the air-conditioning system. When the air-conditioning system performs heating operation, the cold water is replaced by warm water.

When the monitoring target building 51 has the air-conditioning system shown in FIG. 3, the remote performance monitor 1 transmits and receives data shown in FIG. 4. The monitoring data receiver 11 of the remote performance monitor 1 receives the monitoring data including temperature and humidity of the outside air, temperature and a flow rate of the cooling water, temperature and a flow rate of the cold water, a supply amount, temperature and humidity of circulating air, the amounts of energy consumed by the air fans, the amount of energy consumed by the cold water pump, the amounts of energy consumed by the central chillers, the amounts of energy consumed by the cooling towers, loads on air conditioners and a flow rate of cold water from the monitoring data collecting apparatus 5 in the monitoring target building 51. The operating condition transmitter 14 of the remote performance monitor 1 transmits the operating conditions including instructions for the temperature and an sending-returning temperature difference of the cooling water, instructions for the temperature and an sending-returning temperature difference of the chilled water and the system COP of the monitoring target building to the monitoring data collecting apparatus 5 in the monitoring target building 51.

Now, examples of the data to be received by the monitoring data receiver 11 of the remote performance monitor 1 will be described with reference to FIGS. 5A to 5D. FIGS. 5A to 5D show the respective monitoring data that are sequentially transmitted in chronological order. FIG. 5A is a graph showing the power consumption by the air-conditioning machines, namely, the cooling tower, the cooling water pump, the central chiller, and the air fan. FIG. 5B is a graph showing indoor temperature and indoor humidity of a room where the air-conditioner is installed. FIG. 5C is a graph showing the flow rate and the temperature of the cooling water and the temperature of the cooling water returning to the cooling tower. FIG. 5D is a graph showing the COP of the central chiller.

When the monitoring data receiver 11 of the remote performance monitor 1 receives the data as described above, the characteristic function calculator 12 calculates a function of an air-conditioning load on the monitoring target building 51 relative to the outside air temperature and the outside air humidity as the characteristic function of the monitoring target building 51. Here, the air-conditioning load is data received by the monitoring data receiver 11 of the remote performance monitor 1. Alternatively, the air-conditioning load may be calculated by the remote performance monitor 1 based on the data received by the monitoring data receiver 11.

Further, the characteristic function calculator 12 of the remote performance monitor 1 calculates the following functions for each of the air-conditioning machines in the air-conditioning system. Note that the characteristic function calculator 12 may also calculate functions other than the functions described below:

### (1) Concerning the Central Chiller

a function of an efficiency COP of the central chiller in terms of the chilled water temperature of the chilled water produced by the central chiller, the flow rate of the chilled water, the cooling water temperature of the cooling water and the flow rate of the cooling water, and chilling capacity;

### (2) Concerning the Cooling Tower

a function of heat exchange efficiency in terms of the temperature of the outside air, the humidity of the outside air, the cooling water temperature of the cooling water returning to the cooling tower and the flow rate of the cooling water;

### (3) Concerning the Air-Conditioner (the Coil)

a function of an overall heat transmission rate in terms of an amount of the chilled water in the air-conditioner, an air flow rate, temperature of the air and humidity of the air;

### (4) Concerning the Air-Conditioner (the Air Fan)

a function between the amount of energy consumed by the air fan and the air-conditioning load or air flow rate;

### (5) Concerning the Chilled Water Pump

a function between the chilled water pump and the flow rate of the chilled water (excluding bypass); and

### (6) Concerning the Cooling Water Pump

a function between the cooling water pump and the flow rate of the cooling water.

The characteristic function calculator 12 approximates each function by f=ax+b or f=ax²+ax+b and outputs the approximated functions as the characteristic functions, respectively.

The operating condition calculator 13 calculates the optimum operating conditions. Here, the operating condition calculator 13 adjusts the air-conditioning load with the characteristic functions outputted from the characteristic function calculator 12 being the constraints. The operating condition calculator 13 outputs, as the optimum operating conditions, the operating conditions to minimize the sum of the amounts of energy consumed by the respective air-conditioning machines.

The operating conditions to be calculated by the operating condition calculator 13 include the operating condition of the cooling tower, the operating condition of the central chiller and the amount of water. The evaluation function J is expressed by J=Σ (the amount of energy consumed by the central chiller+the amount of energy consumed by the air fan+the amount of energy consumed by the chilled water pump+the amount of energy consumed by the cooling water pump+the amount of energy consumed by cooling tower).

Moreover, when calculating and evaluating the annual building system COP, the operating condition calculator 13 performs evaluation by using, of the monitoring target building 51, the above-described function of the air-conditioning load and the meteorological data of the location, the function relating the temperature and the humidity of the outside air. Though the annual building system COP thus calculated varies according to the state of utilization such as weather in a particular year or on a tenant occupancy rate of the building, in reality, this annual building system COP is deemed as the evaluation value calculated by acquiring the actual data for one year.

### (Multi Packaged Type Air-Conditioner System)

A case where the air-conditioning system of the monitoring target building 51 is of the multi packaged type air-conditioner will be described with reference to FIG. 6 to FIG. 8.

First, a multi packaged type air-conditioner 200 will be described with reference to FIG. 6. The multi packaged type air-conditioner system 200 includes an outdoor unit 201, and indoor units 202a, 202b, 202c, 202d, 202e and 202f. The outdoor unit 201 deals with heat loads on the respective indoor units in a lump. In the example shown in FIG. 6, rooms constituting zones subject to air-conditioning control by the indoor unit 202a are arranged as shown in FIG. 7. The indoor unit 202a is installed in a room A and controls air-conditioning of the room A by operation of the outdoor unit. The indoor units 202b, 202c, 202d, 202e and 202f also have similar configurations to the indoor unit 202a.

When the monitoring target building 51 has the air-conditioning system as shown in FIG. 6, the remote performance monitor 1 transmits and receives data shown in FIG. 8. The monitoring data receiver 11 of the remote performance monitor 1 receives the monitoring data including the temperature and the humidity of the outside air, the supply amount, the temperature and the humidity of the circulating air, the amounts of energy consumed by the air fans, the amounts of energy consumed by the air-conditioners and loads on the air conditioners from the monitoring data collecting apparatus 5 in the monitoring target building 51. The operating condition transmitter 14 of the remote performance monitor 1 transmits the operating conditions including air-conditioner COP, the air-conditioner loads for the respective zones and the system COP of the monitoring target building 51 to the monitoring data collecting apparatus 5 in the monitoring target building 51.

When the monitoring data receiver 11 of the remote performance monitor 1 receives the data as described above, the characteristic function calculator 12 calculates, as the characteristic function of the monitoring target building 51, a function of an air-conditioning load on the monitoring target building 51 relative to the outside air temperature and the outside air humidity. Here, the air-conditioning load is data received by the monitoring data receiver 11 of the remote performance monitor 1. Alternatively, the air-conditioning load may be calculated by the remote performance monitor 1 based on the data received by the monitoring data receiver 11.

Further, the characteristic function calculator 12 of the remote performance monitor 1 calculates the following functions for each of the air-conditioning system. Note that the characteristic function calculator 12 may also calculate functions other than the functions described below:

### (1) Concerning the Air-Conditioner Including the Outdoor Unit and the Indoor Unit

a COP function of the air-conditioner in terms of the outside air temperature and an indoor load; and

### (2) Concerning the Indoor Unit

a function of the overall heat transmission rate of the air-conditioner in terms of the flow rate of the refrigerant in the air-conditioner, the air flow rate, the temperature of the air and the humidity of the air.

Here, the indoor load is the air-conditioning load in the zone which is air-conditioned by a specific air-conditioner, which is similar to the air-conditioner load.

The operating condition calculator 13 calculates the optimum operating conditions. Here, the operating condition calculator 13 adjusts the temperature, the pressure, or the flow rate of refrigerant in the indoor unit with the characteristic functions outputted from the characteristic function calculator 12 being the constraints, and outputs as the optimum operating conditions the operating conditions to minimize the sum of the amounts of energy consumed by the respective air-conditioning machines.

The operating conditions to be calculated by the operating condition calculator 13 include air-conditioning COP and a zone air-conditioning load. The evaluation function J is expressed by J=Σ (the amount of energy consumed by the outdoor unit+the amounts of energy consumed by the indoor units).

Moreover, when calculating and evaluating the annual building system COP, evaluation is executed by using, of the monitoring target building 51, the above-described function of the air-conditioning load and the meteorological data of the location, the function relating the temperature and the humidity of the outside air. Though the annual building system COP thus calculated varies depending on the state of utilization such as weather in a particular year or on the tenant occupancy rate of the building in reality, this annual building system COP is deemed as the evaluation value calculated by acquiring the actual data for one year.

According to the remote performance monitor 1 of the embodiment of the present invention, it is possible not only to acquire the monitoring data of the monitoring target building 51 but also to determine the optimum operating conditions based on the monitoring data. Hence the remote performance monitor 1 can contribute to energy saving and cost saving of the monitoring target building 51.

Meanwhile, in the case of determination of these operating conditions, the remote performance monitor 1 is managed and administered by an expert, and is thereby able to contribute to operation management of the air-conditioning system in accordance with advices of the expert without deploying an expert to every monitoring target building 51. Therefore, according to the remote performance monitor 1 of the embodiment of the present invention, it is possible to manage the air-conditioning machines in the building more efficiently than processing the information for each of the monitoring target buildings 51 separately.

### OTHER EMBODIMENTS

As described above, while the present invention has been described in terms of the embodiments of the present invention, the present invention should not be limited to the description and drawings as part of the disclosure. Various alternative embodiments, practical applications and implementations will be apparent to those skilled in the art from the disclosure.

For example, as for the characteristic function in each of the air-conditioning systems, it is preferable to select an appropriate characteristic function according to the type of the air-conditioning system or the characteristic of the monitoring target building.

As shown FIG. 9, the remote performance monitor 1a can include a parameter sender instead of operating condition calculator 13 and operating condition transmitter 14. The parameter sender sends parameters of the characteristic function, which is calculated by the characteristic function calculator 12. The monitoring data collecting apparatus 5 receives the parameters of the characteristic function to calculate operating condition data by the air-conditioning machines by using parameters of the characteristic function.

Various modifications will become possible for those skilled in the art after receiving the teachings of the present disclosure without departing from the scope thereof.

What is claimed is:

1. A remote performance monitor configured to acquire monitoring data concerning an air-conditioning system of a monitoring target building and to determine an operating condition of the air-conditioning system, the remote performance monitor comprising:
a monitoring data receiver configured to receive monitoring data from a monitoring data collecting apparatus in the monitoring target building, wherein the monitoring data is data concerning performance characteristics of air-conditioning machines installed in the air-conditioning system of the monitoring target building;
a characteristic function calculator configured to calculate a characteristic function for the monitoring target building and for each of the air-conditioning machines based on the monitoring data; and
an operating condition calculator configured to calculate operating condition data to minimize a sum of amounts of energy consumed by the air-conditioning machines by using the characteristic function.

2. The remote performance monitor according to claim 1 wherein,
when the characteristic function of the monitoring target building is calculated,
the monitoring data receiver receives a temperature of outside air and humidity of the outside air on the monitoring target building, and
the characteristic function calculator calculates a function of the air-conditioning load to the temperature and the humidity of the outside air.

3. The remote performance monitor according to claim 1 wherein,
in the case where the air-conditioning system is a central chiller type air-conditioning system,
each air-conditioning machine is any one of a central chiller, a cooling tower, an air-conditioner, a chilled water pump, a cooling water pump and an air fan.

4. The remote performance monitor according to claim 3 wherein,
in the case where the air-conditioning machine is the central chiller,
the monitoring data receiver receives chilled water temperature of chilled water, a flow rate of the chilled water, a cooling water temperature of cooling water and a flow rate of the cooling water, wherein the chilled water is produced by the central chiller and the cooling water is taken into the central chiller and
the characteristic function calculator calculates energy consumption efficiency of the central chiller as the characteristic function.

5. The remote performance monitor according to claim 3 wherein,
in the case where the air-conditioning machine is the cooling tower,
the monitoring data receiver receives outside air temperature, outside air humidity, cooling water temperature of cooling water and a flow rate of the cooling water wherein the cooling water is returning to the cooling tower, and
the characteristic function calculator calculates heat exchange efficiency of the cooling tower as the characteristic function.

6. The remote performance monitor according to claim 3 wherein,
in the case where the air-conditioning machine is the air-conditioner,
the monitoring data receiver receives: flow rate of chilled water; as well as a flow rate, a temperature, and a humidity of each of circulating air and supplied air of the air-conditioner, and
the characteristic function calculator calculates an overall heat transmission rate of the air-conditioner as the characteristic function.

7. The remote performance monitor according to claim 3 wherein,
in the case where the air-conditioning machine is the chilled water pump,
the monitoring data receiver receives an amount of energy consumed by the chilled water pump and a flow rate of chilled water, and
the characteristic function calculator calculates a function of the consumed amount of energy to the flow rate of the chilled water as the characteristic function.

8. The remote performance monitor according to claim 3 wherein,
in the case where the air-conditioning machine is the cooling water pump,
the monitoring data receiver receives an amount of energy consumed by the cooling water pump and a flow rate of cooling water, and
the characteristic function calculator calculates a function of the consumed amount of energy to the flow rate of the cooling water as the characteristic function.

9. The remote performance monitor according to claim 3 wherein,
in the case where the air-conditioning machine is the air fan,
the monitoring data receiver receives an amount of energy consumed by the air fan and an air-conditioning load or air flow rate, and
the characteristic function calculator calculates a function of the amount of energy consumed by the air fan to the air-conditioning load or air flow rate as the characteristic function.

10. The remote performance monitor according to claim 1 wherein,
in the case where the air-conditioning system is a multi packaged type air-conditioner,
the air-conditioning machine is an air-conditioner including an outdoor unit and an indoor unit.

11. The remote performance monitor according to claim 10 wherein,
in the case where the air-conditioning machine is the air-conditioner,
the monitoring data receiver receives outside air temperature and an air-conditioning load on the air-conditioner, and
the characteristic function calculator calculates a function of energy consumption efficiency of the air-conditioner as the characteristic function.

12. A remote performance monitoring method configured to acquire monitoring data concerning an air-conditioning system of a monitoring target building and to determine an operating condition of the air-conditioning system, the remote performance monitoring method comprising:
receiving monitoring data from a monitoring data collecting apparatus in the monitoring target building, wherein the monitoring data is data concerning performance characteristics of air-conditioning machines installed in the air-conditioning system of the monitoring target building;
calculating a characteristic function for the monitoring target building and for each of the air-conditioning machines based on the monitoring data; and
calculating operating condition data to minimize the sum of amounts of energy consumed by the air-conditioning machines by using the characteristic function.

13. The remote performance monitoring method according to claim 12 wherein,
when the characteristic function of the monitoring target building is calculated,
the monitoring data is a temperature of outside air and humidity of the outside air on the monitoring target building, and
the characteristic function is a function of the air-conditioning load to the temperature of the outside air and the humidity of the outside air is calculated in the step of calculating the characteristic function.

14. The remote performance monitoring method according to claim 12 wherein,
in the case where the air-conditioning system is of a central chiller type,
each air-conditioning machine is any one of a central chiller, a cooling tower, an air-conditioner, a chilled water pump, a cooling water pump and an air fan.

15. The remote performance monitoring method according to claim 12 wherein
in the case where the air-conditioning system is a multi packaged type air-conditioner,
the air-conditioning machine is an air-conditioner including an outdoor unit and an indoor unit.

16. A remote performance monitor configured to acquire monitoring data concerning an air-conditioning system of a monitoring target building and to determine an operating condition of the air-conditioning system, the remote performance monitor comprising:
a monitoring data receiver configured to receive monitoring data from a monitoring data collecting apparatus in the monitoring target building, wherein the monitoring data is data concerning performance characteristics of air-conditioning machines installed in the air-conditioning system of the monitoring target building;
a characteristic function calculator configured to calculate a characteristic function for the monitoring target building and for each of the air-conditioning machines based on the monitoring data; and
a parameter sender configured to send parameters of the characteristic function which is calculated by the characteristic function calculator.

17. A remote performance monitoring method configured to acquire monitoring data concerning an air-conditioning system of a monitoring target building and to determine an operating condition of the air-conditioning system, the remote performance monitoring method comprising:
receiving monitoring data from a monitoring data collecting apparatus in the monitoring target building, wherein the monitoring data is data concerning performance characteristics of air-conditioning machines installed in the air-conditioning system of the monitoring target building;
calculating a characteristic function for the monitoring target building and for each of the air-conditioning machines based on the monitoring data; and
sending parameters of the characteristic function which is calculated by the calculating step.
